(19) United States
(12) Patent Application Publication
(10) Pub. No.: US 2015/0143366 A1
(43) Pub. Date: May 21, 2015

(54) OPTIMIZING PLACEMENT OF VIRTUAL MACHINES

(71) Applicants: Shiva Prakash Suragi Math, Bangalore (IN); Venkatesh Raman Ramteke, Bangalore (IN)

(72) Inventors: Shiva Prakash Suragi Math, Bangalore (IN); Venkatesh Raman Ramteke, Bangalore (IN)

(21) Appl. No.: 14/406,595

(22) PCT Filed: Jun. 29, 2012
(86) PCT No.: PCT/IN2012/000465

§ 371 Date: Dec. 9, 2014

(51) Int. Cl. G06F 9/455; H04L 12/911

(52) U.S. Cl. CPC G06F 9/45533; H04L 47/829
USPC 718/1

(57) ABSTRACT

Provided is a method of identifying a virtual machine for placement in a cloud computing environment, wherein the cloud computing environment comprises multiple cloud computing systems. Workload requests of the virtual machine are segregated into fixed workload request and flexible workload request. An optimal cloud computing system is selected in the cloud computing environment to perform fixed workload request and/or flexible workload request of the virtual machine.

### BACKGROUND

Cloud computing has become quite popular in recent years. Generally speaking, cloud computing involves delivery of computing as a service rather than a product, whereby shared resources (software, storage resources, etc.) are provided to computing devices as a service. The resources are shared over a network, which is typically the internet. One of the key reasons behind the success of cloud computing is a technology called virtualization. Virtualization allows creation of a virtual version of a resource, such as an operating system, a hardware platform, storage resource etc. which could be shared, for instance, among different clients. Multiple virtual machines can be created on a host device or server.

### BRIEF DESCRIPTION OF THE DRAWINGS

For a better understanding of the solution, embodiments will now be described, purely by way of example, with reference to the accompanying drawings, in which:

FIG. 1 illustrates a system for optimizing placement of a virtual machine in a cloud computing system, according to an example

FIG. 2 shows a block diagram of a computer system for optimizing placement of a virtual machine, according to an example.

FIG. 3 shows a flow chart of a method of optimizing placement of a virtual machine in a cloud computing system, according to an example.

FIG. 4 illustrates a system for optimizing placement of a virtual machine in a cloud computing system, according to an example.

FIG. 5 shows a flow chart of a method of optimizing placement of a virtual machine in a host computer system, according to an example.

FIG. 6 illustrates workloads of five virtual machines (VMs) and Peak of Sum value when all workloads are running in parallel on a common host computer system, according to an example.

FIG. 7 illustrates Peak of Sum value for five virtual machines (VMs) when their workloads are scheduled over various time periods, according to an example.

### DETAILED DESCRIPTION OF THE INVENTION

A virtual machine (VM) is a software implementation of a machine that executes programs like a physical machine. A virtual machine can be used to perform a variety of tasks. Some of these tasks may include, for example, hosting of multiple operating systems on a physical machine at the same time, testing of a new application on multiple platforms, and server consolidation. Since multiple virtual machines can be hosted on a physical server, it results, among other benefits, in lower costs for hardware acquisition, maintenance, energy and cooling system usage.

Considering the advantages offered by virtual machines, end users (such as an enterprise) are increasingly deploying virtual machines in their organization through a private cloud deployment model and/or a hybrid cloud deployment model. In a private cloud deployment model, it is a cloud computing system (private cloud) of an end user that hosts virtual machines (of the end user). On the other hand, in a hybrid cloud deployment model (hybrid cloud), a cloud computing system of an end user is connected to a public cloud computing system(s) (typically provided by a cloud service provider) which enables an end user to host its virtual machines in its own cloud computing system (private cloud) and/or the public cloud computing system(s). Thus, in a hybrid deployment model, resources, such as virtual machines, can be moved easily from one deployment system to another.

Since multiple cloud service providers can be part of a hybrid cloud, each service provider may offer services at its own terms and cost. For example, each cloud service provider may charge differently for hosting a virtual machine depending on a number of factors, such as the duration for which the virtual machine needs to be hosted, the underlying platform used for hosting the virtual machine and the time at which the virtual machine needs to be run. For instance, a cloud service provider(s) may offer different prices for running a virtual machine at off peak hours or during weekends. These prices could be cheaper than peak hours or weekday charges when the demand for cloud resources is likely to be higher. If one considers the number of cloud service providers and their differential pricing model for running a virtual machine, it can be challenging for an end user to identify an optimal cloud service provider that meets its requirements, such as, cost optimization, service level agreement, policies, security, resource requirements, and the like.

Also, in a typical virtual environment (for example, in a datacenter) there are two categories of workloads. The first category is the “fixed workloads”. These are time sensitive processes that need to be executed and/or made available during certain known time periods such as specific hours of a day or specific days of week etc. For example, most of the processes related to a trading application may constitute the “fixed workloads” since they need to be made available during the time a stock exchange allows trading to customers. The second category is the “flexible workloads”. These are time insensitive that are flexible to be executed any time before a given deadline. For example, backup of data related to an application (for example, a trading application) may be scheduled at a time preferred by a user. Presently, scheduling of the aforesaid type of workloads is driven by a business or an IT policy of an organization. Therefore, there's an opportunity to optimize resource usage related to these two categories of workloads.

Embodiments of the present solution provide methods and systems for optimizing placement of virtual machines in a cloud computing system. Specifically, the embodiments described provide a solution to place virtual machines in a manner that optimizes cost for an end user and meets its other requirements.

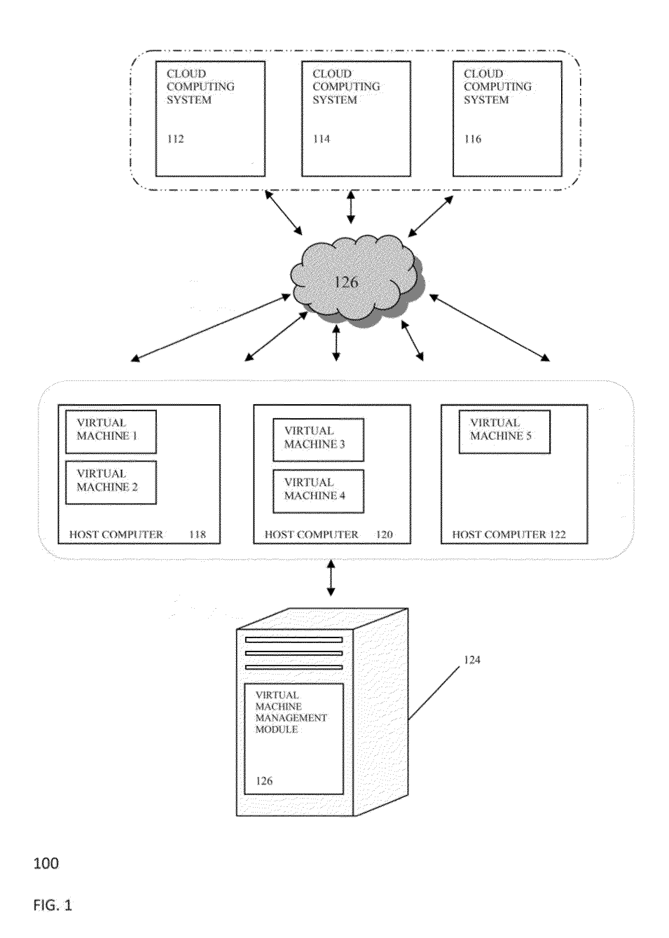

FIG. 1 illustrates a system 100 for optimizing placement of a virtual machine in a cloud computing system, according to an embodiment. Referring to FIG. 1, system 100 includes a network of cloud computing systems 112, 114, 116, host computer systems 118, 120, 122 and a user computer system 124 connected through a computer network 126. Computer network 126 may include connections, such as wire, wireless communication links, or fibre optic cables. In an implementation, computer network 126 is the Internet. However, in other implementations it may be an intranet, a local area network (LAN), wide area network (WAN), or the like.

Client computing systems 112, 114 and 116 may include various computing resources. These computing resources may be hardware resources, software resources, or any combinations thereof. Hardware resources may include computer systems, computer servers, workstations, or any other computer devices. Software resources may include operating system software (machine executable instructions), firmware, and/or application software. Client computing systems 112, 114 and 116 may be provided by different cloud service providers. For example, client computing system 112 may be offered by cloud service provider A, client computing system 114 may be provided by cloud service provider B, and client computing system 116 may be provided by cloud service provider C. In another example, two or more client computing systems may be offered by one cloud service provider. For example, client computing systems 114 and 116 may be provided by cloud service provider A.

In an example, cloud computing systems 112, 114 and 116 provide computing resources to host computer systems 118, 120, 122 and charges host computer systems 118, 120, 122 for their specific use of computing resources. For instance, computing resources may include virtual machines, virtual servers, storage resources, load balancers, firewalls, etc. Generally speaking, cloud computing systems 112, 114 and 116 may constitute a “public cloud”.

Host computer systems 118, 120 and 122, may be, for example, a computer server, desktop computer, notebook computer, tablet computer, mobile phone, personal digital assistant (PDA), or the like. Host computer systems 118, 120 and 122 may include a processor for executing machine readable instructions and a memory (storage medium) for storing machine readable instructions. Host computer systems 118, 120 and 122 are communicatively coupled to cloud computing systems 122, 114, 116 and a user computer system 124 through computer network 126.

In an example, host computer systems 118, 120 and 122 may include a virtual machine(s) (VMs), which can be created through a program called a hypervisor or any other technology which enables multiple VMs to share the computing resource of the host. In the illustrated example, host computer system 118 includes virtual machines 1 and 2 (VM1 and VM2), host computer system 120 includes virtual machines 3 and 4 (VM3 and VM4), and host computer system 122 includes virtual machine 5 (VM5). In an example, host computer systems 118, 120 and 122 are under the control and management of an end user to form a “private cloud’.

User computer systems 124 may be, for example, a computer server, personal computer, desktop computer, notebook computer, tablet computer, mobile phone, personal digital assistant (PDA), or the like.

In an implementation, user computer system 124 may include a virtual machine management module 126. In the example illustration of FIG. 1, virtual machine management module 126 is present on user computer system 124.

However, in other examples, virtual machine management module 126 could be present on another computer system such as host computer systems 118, 120 and 122. In another implementation, virtual machine management module 126 may be present as a distributed program (machine readable instructions) across more than one computer system. For example, components or functions of virtual management module may be distributed across user computer system 124 and host computer systems 118, 120 and 122.

In an implementation, identify a virtual machine for placement in a cloud computing environment, wherein the cloud computing environment comprises multiple cloud computing systems, segregate workload requests of the virtual machine into fixed workload request and flexible workload request, and select an optimal cloud computing system in the cloud computing environment to perform the fixed workload request and/or the flexible workload request of the virtual machine.

Although a limited number of cloud computing systems 112, 114, 116 and host computer systems 118, 120, 122 are illustrated in FIG. 1, some embodiments contemplate including any suitable number of cloud computing systems 112, 114, 116 and host computer systems 118, 120, 122.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system. Further, system 100 may include additional client computer systems, computer servers, and other devices.

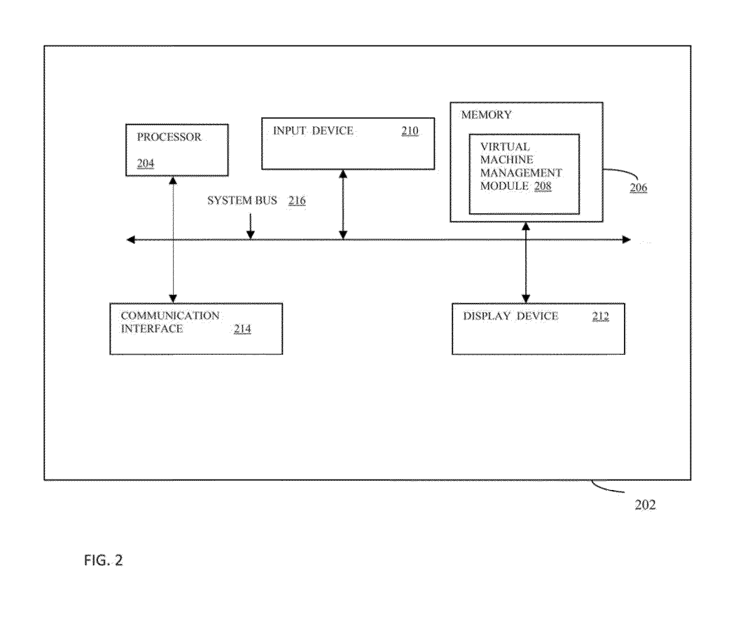

FIG. 2 shows a block diagram of a computer system for optimizing placement of a virtual machine, according to an example.

Computer system 202 may be a computer server, desktop computer, notebook computer, tablet computer, mobile phone, personal digital assistant (PDA), or the like.

Computer system 202 may include processor 204, memory 206, virtual machine management module 208, input device 210, display device 212, and a communication interface 214. The components of the computing system 202 may be coupled together through a system bus 216.

Processor 204 may include any type of processor, microprocessor, or processing logic that interprets and executes instructions.

Memory 206 may include a random access memory (RAM) or another type of dynamic storage device that may store information and instructions non-transitorily for execution by processor 204. For example, memory 206 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. Memory 206 may include instructions that when executed by processor 204 implement virtual machine management module 208.

Virtual machine management module 208 may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

In an implementation, virtual machine management module 208 may be read into memory 206 from another computer-readable medium, such as data storage device, or from another device via communication interface 216.

Input device 210 may include a keyboard, a mouse, a touch-screen, or other input device. Display device 212 may include a liquid crystal display (LCD), a light-emitting diode (LED) display, a plasma display panel, a television, a computer monitor, and the like.

Communication interface 214 may include any transceiver-like mechanism that enables computing device 202 to communicate with other devices and/or systems via a communication link. Communication interface 214 may be a software program, a hard ware, a firmware, or any combination thereof. Communication interface 214 may provide communication through the use of either or both physical and wireless communication links. To provide a few non-limiting examples, communication interface 214 may be an Ethernet card, a modem, an integrated services digital network (“ISDN”) card, etc.

It would be appreciated that the system components depicted in FIG. 2 are for the purpose of illustration only and the actual components may vary depending on the computing system and architecture deployed for implementation of the present solution. The various components described above may be hosted on a single computing system or multiple computer systems, including servers, connected together through suitable means.

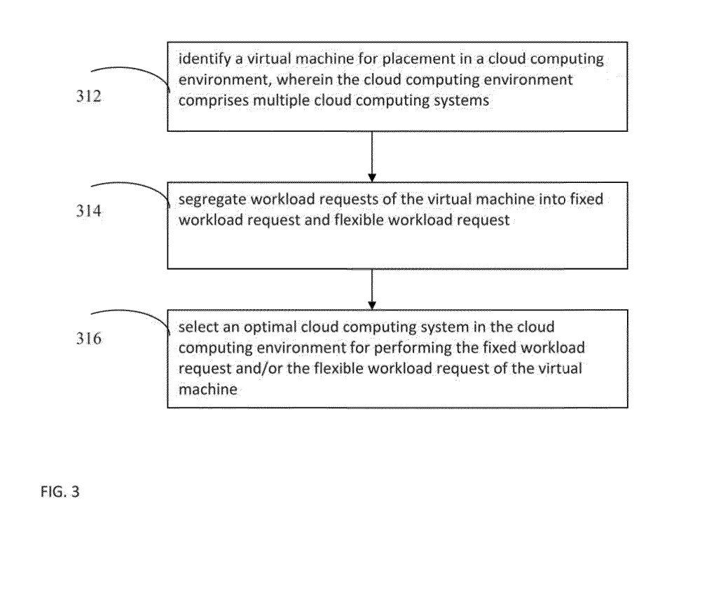

FIG. 3 shows a flow chart of a method of optimizing placement of a virtual machine in a cloud computing system, according to an example. As illustrated in FIG. 3, at block 312, a candidate virtual machine(s) that could be potentially placed in a cloud computing system (private and/or public) is/are selected. In an example, a candidate virtual machine(s) is/are selected by a user, for instance, by compiling a list of virtual machines that could be moved to a cloud. In another example, a candidate virtual machine(s) is/are identified based on a pre-defined policy. Some non-limiting instances of a pre-defined policy could include: (a) business policy: virtual machines belonging to a particular business service (for example, training and development since moving it to a cloud may not much impact a business) and/or (b) Information technology (IT) policy: all virtual machines with processor utilization rate of more than 40%.

In an example, candidate virtual machine(s) are under the control of a user. For instance, candidate virtual machine(s) could be part of a private cloud managed by a user.

In an example, a candidate virtual machine(s) that could be potentially placed in a cloud computing system is/are identified based on its/their utilization during a time period. If a virtual machine is active only for a certain time period but inactive during the rest, it could qualify as a candidate virtual machine for placement in a cloud. Being “active” implies that virtual machine is processing a task or workload. “Inactive” implies that virtual machine is relatively idle during this period.

In an example, selection of a virtual machine(s) for placement in a cloud computing system on the basis of “active/inactive” criterion is performed after an initial set of candidate virtual machine(s) have been identified based on user identification or policy based selection.

At block 314, workload requests of a virtual machine(s) that has been identified for placement in a cloud computing system are analyzed and segregated into two categories: fixed workload requests and flexible workload requests. Fixed workload requests are time sensitive processes that need to be executed and/or made available during certain known time periods such as specific hours of a day or specific days of week etc. On the other hand, flexible workload requests are time insensitive processes that are flexible to be executed any time before a given deadline. In another example, workload classification of a virtual machine may include more than two categories.

At block 316, a cloud computing environment is analyzed to identify and select an optimal cloud computing system(s) for performing fixed workload requests and/or flexible workload requests of the virtual machine(s) identified at block 312. In an example, the cloud computing environment comprises multiple cloud computing systems. The cloud computing systems may be provided by a single cloud service provider or multiple cloud service providers.

Also, in an example, the cloud computing environment may be analyzed to identify a single cloud computing system or multiple cloud computing systems for performing fixed workload requests and/or flexible workload requests of the virtual machine(s). In case a single optimal cloud computing system is identified, both fixed and flexible workload requests of the virtual machine would be handled by the same cloud computing system. In case multiple optimal cloud computing systems are identified, fixed and flexible workload requests of the virtual machine may be handled by different cloud computing systems of the cloud computing environment.

In an example, the basis for selecting an optimal cloud computing system for performing fixed or flexible workload requests of a virtual machine is the cost of performing these requests. The cloud computing system which offers the least cost for performing fixed or flexible workload requests is selected. Thus, in an example, in case there are multiple cloud service providers with each service provider providing its own cloud computing system, then the cloud service provider which offers least cost for running the fixed or flexible workload requests of the virtual machine is selected for placement (or hosting) of the virtual machine.

In another example, an alternate or additional basis of selecting a cloud computing system includes identifying a cloud service provider that meets a service level agreement (SLA) of an end user. In a yet another example, an alternate or additional basis of selecting a cloud computing system includes identifying a cloud service provider that meets resource requirements of the virtual machine that is to be hosted.

In an example, fixed workload requests of a virtual machine are moved to a cloud computing system if the cost of movement is less than the cost of performing these requests at end user's resources (for example, in a private cloud of a user).

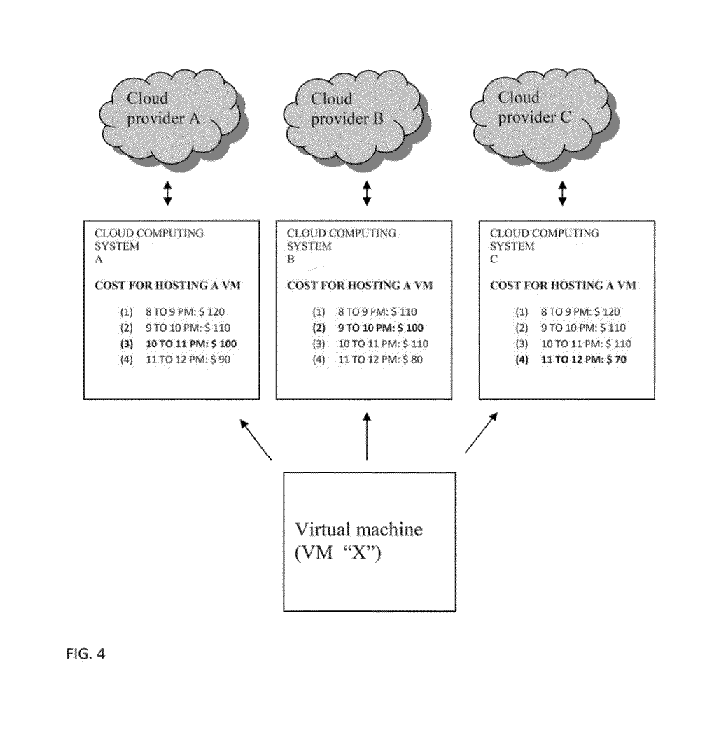

In an example, flexible workload requests of a virtual machine are moved to a cloud computing system if the cost of movement is less than the cost of performing these requests at end user's resources (for example, in a private cloud of an user). Additionally, for flexible workload requests of a virtual machine, multiple cloud computing systems may be selected to perform these requests, based on, for instance, cost, SLA, and other requirements. In such case, each cloud computing system may partially perform a flexible workload request until its optimality (for example, least cost) is exhausted for an end user. To provide an example (Illustrated in FIG. 4), consider a scenario where three cloud computing systems A, B and C (from as many cloud service providers i.e. cloud provider A, cloud provider B and cloud provider C) are selected to perform flexible workload requests of a virtual machine (VM “X”), wherein the flexible workload requests need to be executed between 9 and 12 PM. If cost is the basis for selection of a cloud computing system, then let us assume that cloud computing system A offers least cost (of hosting a virtual machine) between 10 and 11 PM, cloud computing system B offers least cost between 9 and 10 PM, and cloud computing system C offers least cost between 11 and 12 PM. In such case, cloud computing system B would be selected first since it offers the least cost between 9 and 10 PM when the flexible workload requests of a virtual machine need to begin, then cloud computing system A would be selected since it offers the least cost between 10 and 11 PM and, finally, cloud computing system C would be selected since it offers the least cost between 11 and 12 PM.

As mentioned earlier, cost may not be the only criterion for selecting a cloud computing system for performing fixed or flexible workload requests of a virtual machine, there may be alternate or additional factors as well, which may include, for instance, by way of example only, SLA requirements and resource needs of an end user.

In an alternate embodiment, virtual machines that are identified to have fixed as well as flexible workload requests may be consolidated within the resource infrastructure of a user. For example, in case of a virtualized data center, if there are multiple virtual machines that run both fixed and flexible workload requests, then flexible workload requests of multiple virtual machines can be aggregated in a manner that resource utilization (for example, host server usage) is optimized thereby providing cost reduction and other benefits to a user.

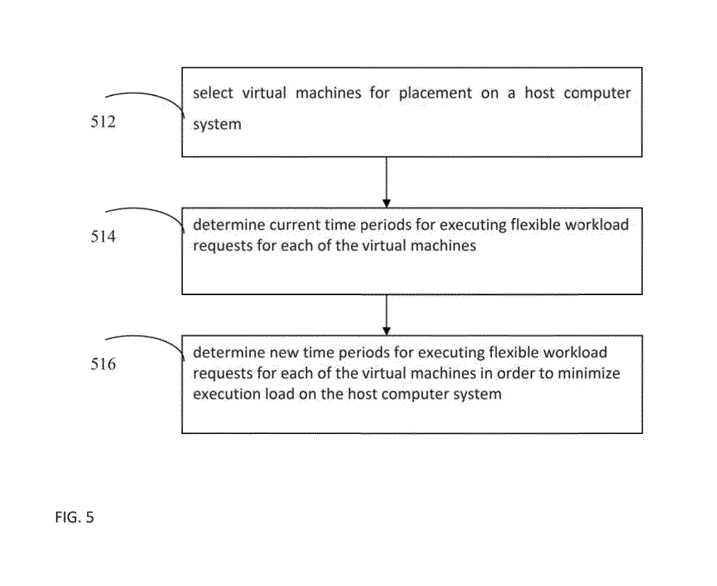

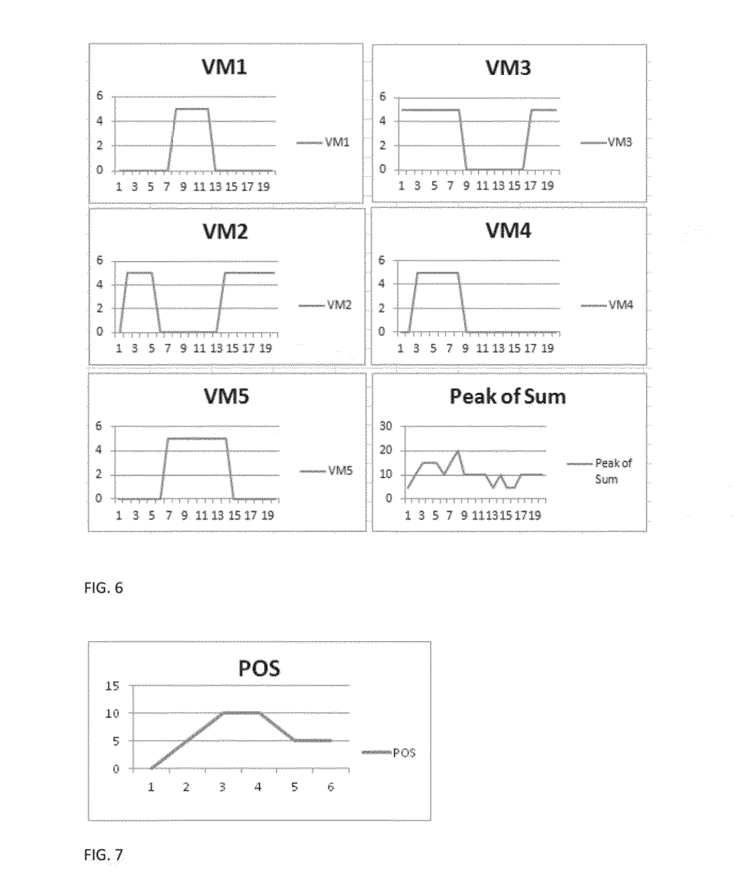

Resource usage optimization at a user's end (for example, in a private cloud or a virtualized data center of the end user) may take place as follows (illustrated in FIG. 5). At block 512, candidate virtual machines that could be potentially aggregated together on a single host are selected. In an example, candidate virtual machines are selected by a user. In another example, candidate virtual machines are identified based on a pre-defined policy. Some non-limiting instances of a pre-defined policy could include: (a) business policy: virtual machines belonging to a particular business service (for example, training and development since moving it to a cloud may not much impact a business) and/or (b) Information technology (IT) policy: all virtual machines with processor utilization rate of more than 40%. In another example, candidate virtual machines are identified based on their utilization during a time period. If a virtual machine is active only for a certain time period but inactive during the rest, it could qualify as a candidate virtual machine for aggregation on a host computer system. Being “active” implies that virtual machine is processing a task or workload. “Inactive” implies that virtual machine is relatively idle during this period.

Next, workload requests of virtual machines that have been selected for consolidation are analyzed and segregated into two categories: fixed workload requests and flexible workload requests. Fixed workload requests are time sensitive processes that need to be executed and/or made available during certain known time periods such as specific hours of a day or specific days of week etc. On the other hand, flexible workload requests are time insensitive processes that are flexible to be executed any time before a given deadline.

At block 514, current time periods for executing flexible workload requests is determined for each of the selected virtual machines. At block 516, new time periods for executing flexible workload requests is determined for each of the selected virtual machines in order to minimize execution load on the host computer system. In an example, new time periods for executing flexible workload requests are determined by performing a Peak of Sum analysis (PoS) on virtual machines' utilization trace against the capacity of the host computer system. Lower resource utilization on a host computer system is achieved if the virtual machines are placed in a manner such that their utilization periods are shifted over time. The following paragraphs describe a method that can be used to determine an optimal sequence of placement of virtual machines on a host computer system such that their utilization across the host is uniform. To illustrate the method, let's consider an example of five virtual machines (VM1, VM2, VM3, VM4 and VM5) where each virtual machine has an independent flexible workload retrace sequence as illustrated in FIG. 6. The method finds out a ‘Peak of Sum’ or POS value which indicates the maximum load that would be put on a host if all five VMs are placed together. If flexible workload request of all five VMs are executed in parallel on a host computer system, then the ‘Peak of Sum’ or POS section in FIG. 1 indicates that the maximum load on a host will be 20 GHz. The approach described below identifies an optimum sequence of executing workload requests of multiple virtual machines such that the peak VM loads on a host computer system is least over a defined time period.

The method begins with creating utilization segments for each virtual machine (stage 1). This is done by analyzing utilization trace for all five virtual machines. Based on FIG. 6, utilization segments for each virtual machine are illustrated in Table 1.

TABLE 1

| Segment # | VM1 | VM2 | VM3 | VM4 | VM5 |
|---|---|---|---|---|---|
| 0 | 0 | 0 | 5 | 0 | 0 |
| 1 | 5 | 5 | 0 | 5 | 5 |
| 2 | 0 | 0 | 5 | 0 | 0 |
| 3 | — | 5 | — | — | — |

Next, an index position is assigned to each of five virtual machines (stage 2). The index position is assigned to virtual machines based on ascending value of virtual machines' Average Segment Value. Average Segment Value based on Table 1 is shown in Table 2. Position Index is assigned to each of the virtual machines based on its Average Segment Value.

TABLE 2

| | Avg. Segment | |
|---|---|---|
| | Value | Position index |
| VM1 | 1.6 | 0 |
| VM2 | 2.5 | 3 |
| VM3 | 3.3 | 4 |
| VM4 | 1.6 | 1 |
| VM5 | 1.6 | 2 |

Then, VM placement sequence numbers are obtained from the first column of N×N matrix (stage 3). A N×N matrix is created, where N indicates the count of VMs to be analyzed. After creating the matrix, the index values are extracted from 1st column of the matrix. Only columns where 1st index in the column is equal to 0 are considered.

TABLE 3
Row 0: [0][0][0][0][0]
Row 1: [0][0][0][1][0]
Row 2: [0][0][0][2][0]
Row 3: [0][0][0][3][0]
Row 4: [0][0][1][0][0]
. . .
. . .
: [0][0][3][2][0]
Last Row: [0][0][3][3][0]

Next, each row's Index sequence is expanded to obtain possible VM placement sequence (stage 4).

VM placement sequence at each row is obtained by incrementing each column's sequence set's value by one. Creating new columns for a row is stopped when all of the index values in a column are equal to maximum segment count OR all rows are marked by symbol ‘x’.

To provide an example, for Row 2, Column 1, value is [0][0][0][2][0].

The second column value for same row is obtained by incrementing index values by 1. i.e. [1][1][1][3][1].

Similarly third column value for same row is obtained by incrementing index values by 1. The position whose value is equal to maximum segment count is replaced by symbol ‘x’ in subsequent column generations. Obtained sequence is [2][2][2][x][2]

Similarly fourth column value for same row is [3][3][3][x][3]

Fifth column value is not generated as now all index values are same as

TABLE 4

| | | | | |
|---|---|---|---|---|
| Row 0 | [0][0][0][0][0] | [1][1][1][1][1] | [2][2][2][2][2] | [3][3][3][3][3] |
| Row 1 | [0][0][0][1][0] | [1][1][1][2][1] | [2][2][2][3][2] | [3][3][3][x][3] |
| Row2 | [0][0][0][2][0] | [1][1][1][3][1] | [2][2][2][x][2] | [3][3][3][x][3] |
| Row3 | [0][0][0][3][0] | [1][1][1][x][1] | [2][2][2][x][2] | [3][3][3][x][3] |
| | . . . | | | |
| | . . . | | | |
| | [0][0][3][2][0] | [1][1][x][3][1] | [2][2][x][x][2] | [3][3][x][x][3] |
| Last Row | [0][0][3][3][0] | [1][1][x][x][1] | [2][2][x][x][2] | [3][3][x][x][3] |

In the next stage (stage 5), Peak of Sum value for each column is calculated (stage 4). Peak of Sum value for VM utilization is calculated using Position Index from Table 4.

The Position Index maps each element of sequence in Table 4. To provide an example, based on sequence in Row 2 and column 1 and Table 1:

TABLE 5

| | VM1 | VM4 | VM5 | VM2 | VM3 |
|---|---|---|---|---|---|
| Row 2, Column 1 | [0] | [0] | [0] | [3] | [0] |
| Segment Value | 0 | 0 | 5 | 0 | 0 |

The Peak of Sum value for index sequence shown in Table 5 is 5. Similarly, Peak of Sum values for all the index sequences is calculated in constructed matrix during first stage of the method (Table 4). The POS value is shown against each cell value separated by “=” symbol. It is to be noted that any index value with ‘x’ is not considered by analysis

TABLE 6

| | | | | |
|---|---|---|---|---|
| Row 1 | [0][0][0][0][0] = 10 | [1][1][1][1][1] = 15 | [2][2][2][2][2] = 10 | [3][3][3][3][3] = 5 |
| Row 2 | [0][0][0][1][0] = 15 | [1][1][1][2][1] = 10 | [2][2][2][3][2] = 10 | [3][3][3][x][3] = 5 |
| Row3 | [0][0][0][2][0] = 10 | [1][1][1][3][1] = 10 | [2][2][2][x][2] = 10 | [3][3][3][x][3] = 5 |
| Row4 | [0][0][0][3][0] = 15 | [1][1][1][x][1] = 10 | [2][2][2][x][2] = 10 | [3][3][3][x][3] = 5 |
| | . . . | | | |
| | . . . | | | |
| | [0][0][3][2][0] = 10 | [1][1][x][3][1] = 15 | [2][2][x][x][2] = 5 | [3][3][x][x][3] = 0 |
| Last Row | [0][0][3][3][0] = 10 | [1][1][x][x][1] = 10 | [2][2][x][x][2] = 5 | [3][3][x][x][3] = 0 |

Subsequently, a row is selected such that POS value for the row is minimum across all the rows (stage 6).

TABLE 9

| | | | | | |
|---|---|---|---|---|---|
| Row 1 | [0][0][0][0][0] = 5 | [1][1][1][1][1] = 15 | [2][2][2][2][2] = 10 | [3][3][3][3][3] = 5 | Min POS: 15 |
| Row 2 | [0][0][0][1][0] = 10 | [1][1][1][2][1] = 10 | [2][2][2][3][2] = 10 | [3][3][3][x][3] = 5 | Min POS: 10 |
| Row3 | [0][0][0][2][0] = 5 | [1][1][1][3][1] = 10 | [2][2][2][x][2] = 10 | [3][3][3][x][3] = 5 | Min POS: 10 |
| Row4 | [0][0][0][3][0] = 10 | [1][1][1][x][1] = 10 | [2][2][2][x][2] = 10 | [3][3][3][x][3] = 5 | Min POS: 10 |
| | . . . | | | | |
| | . . . | | | | |
| | [0][0][3][2][0] = 10 | [1][1][x][3][1] = 15 | [2][2][x][x][2] = 5 | [3][3][x][x][3] = 0 | Min POS: 15 |
| Last Row | [0][0][3][3][0] = 10 | [1][1][x][x][1] = 10 | [2][2][x][x][2] = 5 | [3][3][x][x][3] = 0 | Min POS: 10 |

Based on Table 6 constructed in stage 5, minimum POS value across all columns is calculated for each row (Table 7).
a. Based on analysis of Table 7, below row is obtained as the one with minimum POS of 10.

TABLE 8

| | | | |
|---|---|---|---|
| [0][1][2][0][0] = 10 | [1][2][3][1][1] = 10 | [2][3][x][2][2] = 5 | [3][x][x][3][3] = 0 |

Next, selected row's sequence is interpreted to identify a VM placement (stage 7). Interpreting the resultant VM placement sequence from stage 4 (Table 8) involves analysis of column 1 of selected row.

TABLE 9

| VM1 | VM4 | VM5 | VM2 | VM3 |
|---|---|---|---|---|
| [0] | [1] | [2] | [0] | [0] |

VM placement with respect to the first column of a selected row is [0][1][2][0][0] or defined with respect to VMs (Table 9) as follows:

0th data index of VM1 aligned with
1st data index of VM4 aligned with
2nd data index of VM5 aligned with
0th data index of VM2 aligned with
0th data index of VM3

TABLE 10

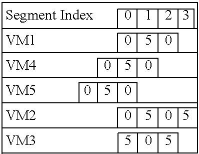

As illustrated in FIG. 6, the total VM Placement load by the aforementioned approach is at peak of 10 Ghz as compared to 20 Ghz illustrated in FIG. 5. In other words, the Peak of Sum (PoS) value for the virtual machines over the new time periods is lower than Peak of Sum (PoS) value for the virtual machines over the current time periods. Therefore, lower resource utilization on a host is achieved if virtual machines are scheduled for execution on host over different time periods. Thus, the embodiments provide significant benefits (in terms of resource usage) if optimal scheduling of workloads is carried out.

It would be appreciated that the system components depicted in FIG. 1 are for the purpose of illustration only and the actual components may vary depending on the computing system and architecture deployed for implementation of the present solution. The various components described above may be hosted on a single computing system or multiple computer systems, including servers, connected together through suitable means.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A method of optimizing placement of a virtual machine, comprising:
identifying a virtual machine for placement in a cloud computing environment, wherein the cloud computing environment comprises multiple cloud computing systems;
segregating workload requests of the virtual machine into fixed workload request and flexible workload request; and
selecting an optimal cloud computing system in the cloud computing environment for performing the fixed workload request and/or the flexible workload request of the virtual machine.

2. The method of claim 1, wherein selecting the optimal cloud computing system comprises identifying a least cost cloud computing system amongst the multiple cloud service providers.

3. The method of claim 1, wherein selecting the optimal cloud service provider comprises identifying a cloud computing system that meets a service level agreement (SLA).

4. The method of claim 1, wherein selecting the optimal cloud computing system comprises identifying a cloud computing system that meets a resource requirement of the virtual machine.

5. The method of claim 1, wherein selecting the optimal cloud computing system comprises comparing cost of placing the virtual machine amongst the multiple cloud computing systems.

6. The method of claim 1, wherein the virtual machine for placement in a cloud computing environment is identified based on a pre-defined policy or by a user.

7. A method of optimizing placement of virtual machines, comprising:
selecting virtual machines for placement on a host computer system;
determining current time periods for executing flexible workload requests for each of the virtual machines; and
determining new time periods for executing flexible workload requests for each of the virtual machines in order to minimize execution load on the host computer system.

8. The method of claim 7, wherein selecting virtual machines for placement on a host computer system includes determining whether the virtual machines execute flexible workloads requests.

9. The method of claim 7, wherein determining new time periods for executing flexible workload requests for each of the virtual machines includes determining a Peak of Sum (PoS) value for the virtual machines over the new time periods.

10. The method of claim 9, wherein the Peak of Sum (PoS) value for the virtual machines over the new time periods is lower than Peak of Sum (PoS) value for the virtual machines over the current time periods for executing flexible workload requests for each of the virtual machines.

11. A computing system, comprising:
a processor;
a non-transitory memory coupled to the processor, the memory comprising a virtual machine management module that, when executed by the processor, causes the processor to:
identify a virtual machine for placement in a cloud computing environment, wherein the cloud computing environment comprises multiple cloud computing systems;
segregate workload requests of the virtual machine into fixed workload request and flexible workload request; and
select an optimal cloud computing system in the cloud computing environment to perform the fixed workload request and/or the flexible workload request of the virtual machine.

12. The system of claim 11, wherein the optimal cloud computing system is a hybrid cloud computing system.

13. The system of claim 11, wherein the multiple cloud computing systems are hosted by different cloud service providers.

14. The system of claim 11, wherein the optimal cloud computing system to perform the fixed workload request and the flexible workload request of the virtual machine are different.

15. A non-transitory computer readable medium, the non-transitory computer readable medium comprising machine executable instructions, the machine executable instructions when executed by a computer system causes the computer system to:
identify a virtual machine for placement in a cloud computing environment, wherein the cloud computing environment comprises multiple cloud computing systems;
segregate workload requests of the virtual machine into fixed workload request and flexible workload request; and
select an optimal cloud computing system in the cloud computing environment to perform the fixed workload request and/or the flexible workload request of the virtual machine.
